(19) United States
(12) Patent Application Publication
(10) Pub. No.: US 2026/0148344 A1
(43) Pub. Date: May 28, 2026

(54) CONTROLLABLE IMAGE SYNTHESIS USING EDITABLE IMAGE ELEMENTS

(71) Applicant: ADOBE INC., SAN JOSE, CA (US)

(72) Inventors: Jiteng Mu, San Diego, CA (US); Michael Gharbi, San Francisco, CA (US); Richard Zhang, Burlingame, CA (US); Elya Shechtman, Seattle, WA (US); Taesung Park, Sunnyvale, CA (US); Xiaolong Wang, San Diego, CA (US); Nuno Miguel Vasconcelos, San Diego, CA (US)

(21) Appl. No.: 18/956,508

(22) Filed: Nov. 22, 2024

(51) Int. Cl. G06T 5/60; G06N 3/0455; G06T 5/50; G06T 7/11

(52) U.S. Cl. CPC G06T 5/60; G06N 3/0455; G06T 5/50; G06T 7/11; G06T 2207/20081; G06T 2207/20092

(57) ABSTRACT

A method, apparatus, non-transitory computer readable medium, and system for controllable image synthesis using image elements include obtaining an image depicting a scene and encoding, using an encoder of an image generation model, a first region of the image to obtain a first encoded image element. A transformation is applied to the first encoded image element to obtain a transformed image element, where the transformation modifies an object in the scene located withing the first region of the image. A decoder of the image generation model generates an edited image depicting the scene with the modified object based on the transformed image element.

### BACKGROUND

The following relates generally to image processing, and more specifically to image generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image generation is a type of image processing that involves the creation of synthetic images. Recently, generative artificial intelligence (AI) models have been developed to generate realistic images. One such model is the Denoising Diffusion Probabilistic Model (DDPM). DDPMs generate samples by transforming an initial random noise distribution into a data distribution over a series of time steps. In some cases, a DDPM can be conditioned on a text description, such that the diffusion process generates images that match the text. However, textual description can be insufficient to describe desired user edits such as spatial transformations to an image.

### SUMMARY

Embodiments of the present inventive concepts described herein include systems and methods for editing images by encoding multiple image elements. Embodiments include a segmentation component configured to segment an input image into a plurality of regions, and an image generation model including a region encoder. The region encoder encodes the image data in each region to generate embeddings. The resulting image element includes the region centroid and bounding box from the segmentation process, and the embedding. The system then stores the plurality of image elements to represent the entirety of the input image. A user can then make various edits to the regions via a user interface, such as deletion and spatial transformations. The centroids and bounding boxes of the corresponding image elements are then updated based on the edits to form an updated set of image elements. A decoder of the image generation model then processes the updated set of image elements along with an optional text prompt to generate a synthetic image seamlessly depicting the user edit.

A method, apparatus, non-transitory computer readable medium, and system for controllable image generation are described. One or more aspects of the method, apparatus, non-transitory computer readable medium, and system include obtaining an image depicting a scene; encoding, using an encoder of an image generation model, a first region of the image to obtain a first encoded image element; applying a transformation to the first encoded image element to obtain a transformed image element, wherein the transformation modifies an object in the scene located withing the first region of the image; and generating, using a decoder of the image generation model, an edited image depicting the scene with the modified object based on the transformed image element.

A method, apparatus, non-transitory computer readable medium, and system for controllable image generation are described. One or more aspects of the method, apparatus, non-transitory computer readable medium, and system include segmenting an image to obtain a first region of the image; encoding, using an encoder of an image generation model, the first region of the image to obtain a first encoded image element; editing the first encoded image element based on a user edit to obtain a transformed image element; and generating, using a decoder of the image generation model, an edited image based on the transformed image element.

A method, apparatus, non-transitory computer readable medium, and system for training a machine learning model are described. One or more aspects of the method, apparatus, non-transitory computer readable medium, and system include obtaining training data including an image depicting a scene with an object in a first region; encoding the first to obtain a first encoded image element; training, using the training data, an image generation model to generate an edited image depicting the object based on the first encoded image element.

An apparatus, system, and method for controllable image generation are described. One or more aspects of the apparatus, system, and method include at least one processor; at least one memory storing instructions executable by the at least one processor; and an image generation model comprising parameters stored in the at least one memory, wherein the image generation model is trained encode a plurality of regions of an input image to obtain a plurality of encoded image elements, to obtain a transformed image element corresponding to at least one or the encoded image elements, and to generate an edited image based on the plurality of encoded image elements including the transformed image element.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a guided latent diffusion model according to aspects of the present disclosure.

FIG. 4 shows an example of a U-Net architecture according to aspects of the present disclosure.

FIG. 5 shows an example of a pipeline for controllable image synthesis according to aspects of the present disclosure.

FIG. 6 shows an example of a pipeline for generating edited images from image elements according to aspects of the present disclosure.

FIG. 7 shows an example of a method for performing a diffusion process according to aspects of the present disclosure.

FIG. 8 shows an example of a method for providing an edited image to a user according to aspects of the present disclosure.

FIG. 9 shows an example of a method for controllable image synthesis according to aspects of the present disclosure.

FIG. 10 shows an example of an algorithm for training a machine learning model according to aspects of the present disclosure.

FIG. 11 shows an example of a method for training a diffusion model according to aspects of the present disclosure.

FIG. 12 shows an example of a method for staged training according to aspects of the present disclosure.

FIG. 13 shows an example of results of the image element pipeline as compared to conventional editing approaches according to aspects of the present disclosure.

FIG. 14 shows an example of a computing device according to aspects of the present disclosure.

### DETAILED DESCRIPTION

Image generation is frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention. Generative models in ML are algorithms designed to generate new data samples that resemble a given dataset. Generative models are used in various fields, including image generation. They work by learning patterns, features, and distributions from a dataset and then using this understanding to produce new, original outputs.

Image editing can be a labor-intensive process. Although users can quickly and easily rearrange parts of an image to compose a new one, simple edits can easily look unrealistic when the scene lighting and physical interactions between objects become inconsistent. Fixing these issues manually to make the edit plausible can use significant time and skill, and sometimes involve pixel level edits. Image edits can include various operations on image content such as cropping, resizing, adjusting brightness and contrast, and removing unwanted portions. In some cases, these methods also involve more complex tasks like retouching, compositing, and color correction.

Recently, users have applied generative ML systems to image editing. Some generative methods utilize text-to-image diffusion models, which are not originally designed for input image handling. Conventional approaches attempt to leverage input content by inverting the image into noise maps or text embeddings, or by initiating denoising from intermediate noise levels. Other techniques condition on specific modalities such as depth maps or pose estimations. These methods can struggle with spatial layout changes or preserving detailed content from the original image.

Autoencoder designs have emerged as a potential solution for image editing tasks. These systems typically employ an encoder to capture input content and a decoder to integrate editing operations. Some autoencoder approaches in GAN settings have demonstrated structure-preserving texture editing by decomposing the latent space. Diffusion-based autoencoders have also been developed, training encoders jointly with diffusion-based decoders to capture holistic image content. However, these methods often face a trade-off between reconstruction accuracy and spatial editing capability. Large spatial dimensions in latent codes can prove challenging for editing techniques like interpolation. Additionally, while some generative models have explored layout control and object manipulation, many of these systems are not well-suited for editing existing input images, as their layout conditioning may not adequately represent all input content.

In contrast, embodiments of the present disclosure comprehensively encode all input contents into image elements. Accordingly, embodiments improve on existing image generation and generative editing systems by improving the accuracy of the resulting generated images by leveraging all of the content from the input image in the form of intuitive, editable visual elements. Edits to the image elements, as opposed to a singular input edit condition, result in a robust input condition that more accurately preserves visual features from the original image. Embodiments segment an image into similarly-sized regions, each associated with a centroid point and a bounding box. An image encoder is trained to encode each region to obtain a region embedding, which is associated with the centroid and the bounding box to form an image element. Through a user interface, users can apply deletions or spatial transformations to the image regions to indicate a desired edit. The edits are represented as changes to the bounding box, centroid, and in some cases, region embedding of the corresponding image element(s). The altered set of image elements is then input to a finetuned image decoder to generate an edited image that seamlessly depicts the edit, with the same visual features as the input image.

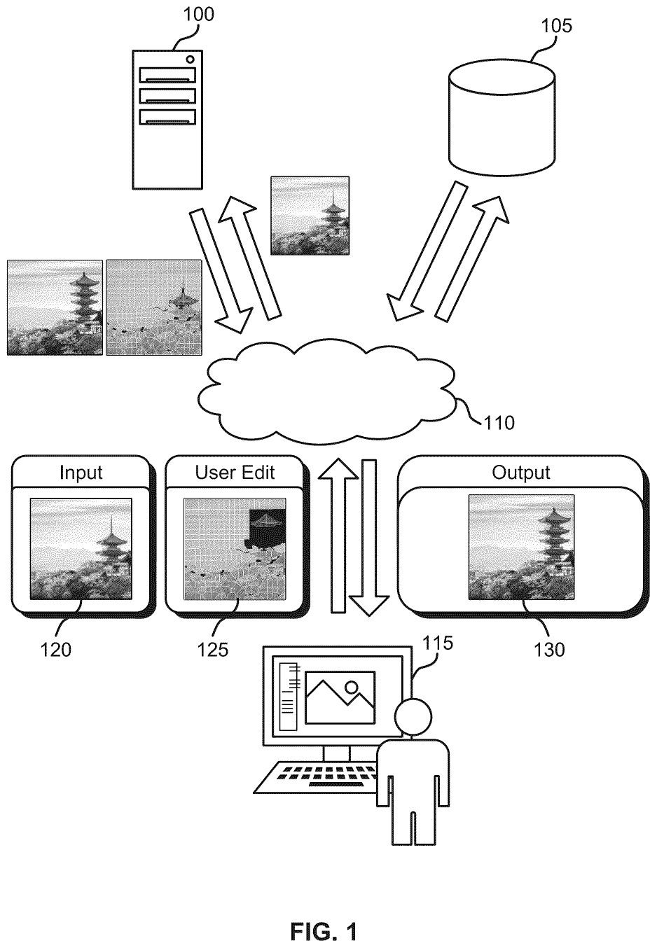

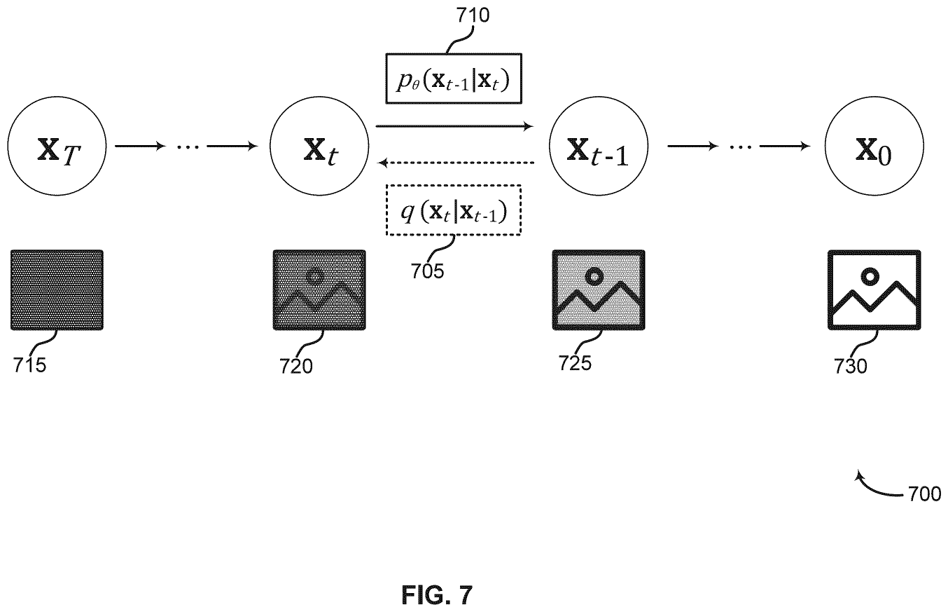

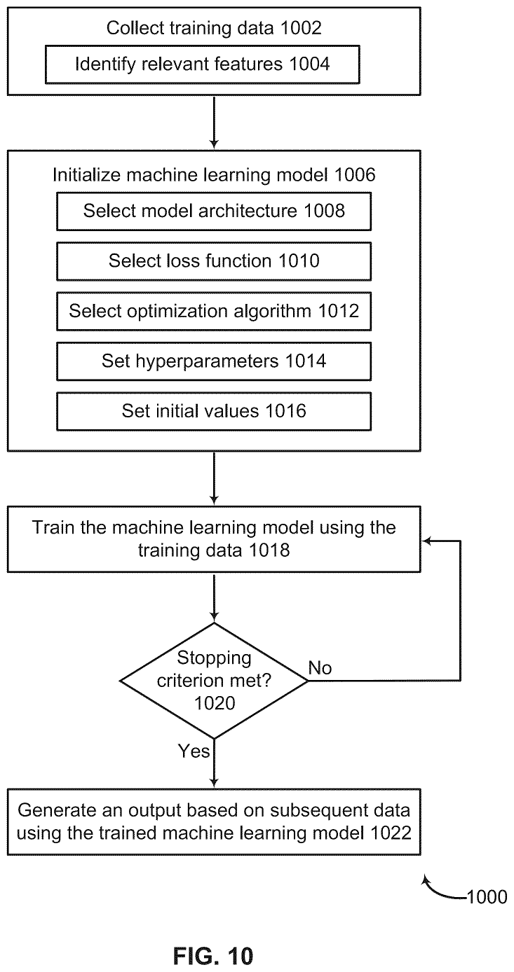

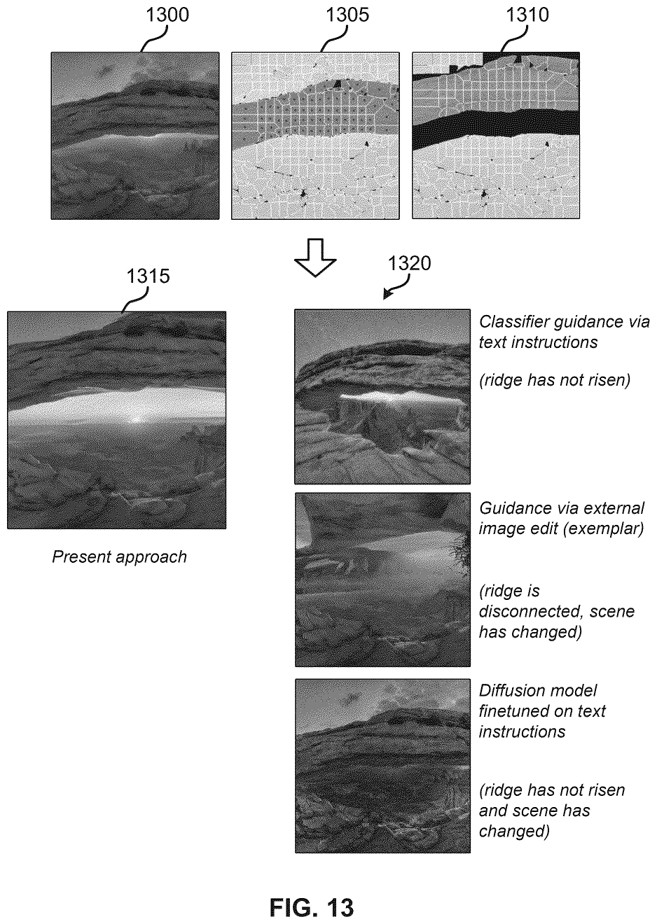

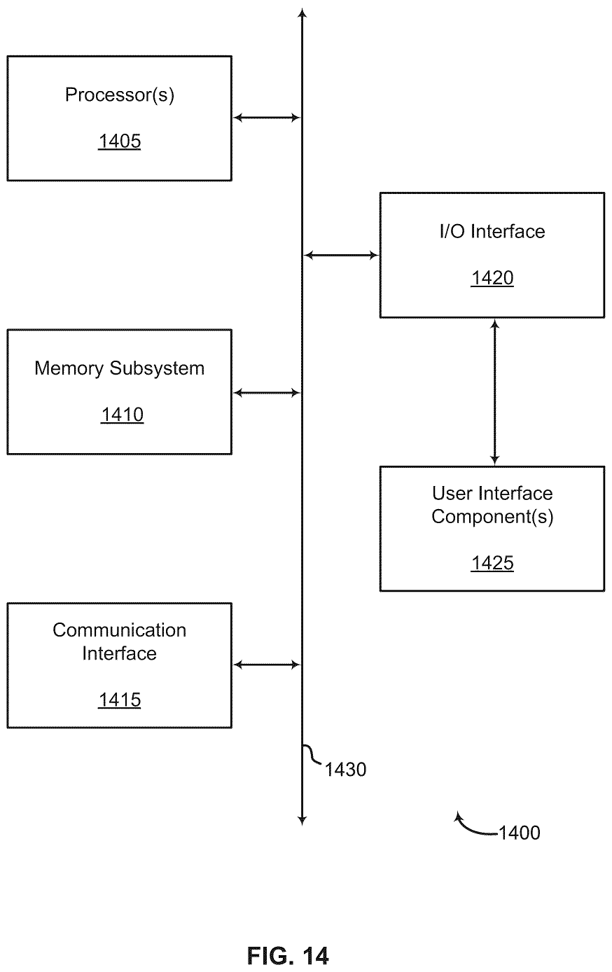

An image processing system configured to generate image elements and an edited image from the image elements is described with reference to FIGS. 1-6. Methods for generating the edited images are described with reference to FIGS. 7-9. Training methods are described with reference to FIGS. 10-12. Results of the outputs of the present embodiments, as contrasted with conventional approaches, are described with reference to FIG. 13. A computing device configured to implement an image processing apparatus is described with reference to FIG. 14.

### Image Processing System

FIG. 1 shows an example of an image processing system according to aspects of the present disclosure. The example shown includes image processing apparatus 100, database 105, network 110, user interface 115, input image 120, input user edit 125, and output image 130.

In an example use case, a user provides input image 120 via user interface 115. The image processing apparatus 100 processes input image 120 and provides a segmented version of the image including selectable regions. The user selects some of the regions, and applies a transformation such as a dragging, resizing, or deletion operation to produce input user edit 125. The image processing apparatus 100 then processes input user edit 125 to generate a seamless depiction of the edit, for example, output image 130. In some examples, such as when the user deletes a large number of segments, the user may additionally provide a text prompt to guide the generation. For example, the user may describe a new object to insert in the deleted regions or prompt the system to infill the regions with background content.

Embodiments of image processing apparatus 100 include components that are implemented on a server. A server provides one or more functions to users linked by way of one or more of available networks, such as network 110. In some cases, the server includes a single microprocessor board, which includes a microprocessor responsible for controlling all aspects of the server. In some cases, a server uses microprocessors and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 stores information used by the image processing system, such as model parameters, embeddings, training data, instructions and code libraries, stock images, previously generated images, and the like. A database is an organized collection of data. For example, database 105 stores data in a specified format known as a schema. A database may be structured as a single database, a distributed database, multiple distributed databases, or an emergency backup database. In some cases, a database controller may manage data storage and processing in database 105. In some cases, a user interacts with the database controller. In other cases, the database controller may operate automatically without user interaction.

Network 110 facilitates the transfer of information between image processing apparatus 100, database 105, and a user, e.g. via user interface 115. Network 110 may be referred to as a “cloud.” A cloud is a computer network configured to provide on-demand availability of computer system resources, such as data storage and computing power. In some examples, the cloud provides resources without active management by a user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User interface 115 enables a user to interact with the image processing system. In some embodiments, the user interface may include an audio device, such as an external speaker system, an external display device such as a display screen, or an input device (e.g., remote control device interfaced with the user interface directly or through an IO controller module). In some cases, a user interface may be a graphical user interface (GUI).

According to some aspects, image processing apparatus 100 obtains an image depicting a scene. In some examples, image processing apparatus 100 applies a transformation to an encoded image element of the set of encoded image elements to obtain a transformed image element, where the transformation modifies an object in the scene. The transformation may be obtained from a user operating a user interface. In some examples, image processing apparatus 100 changes the value of the location or the value of the bounding box of the encoded image element to obtain the transformed image element.

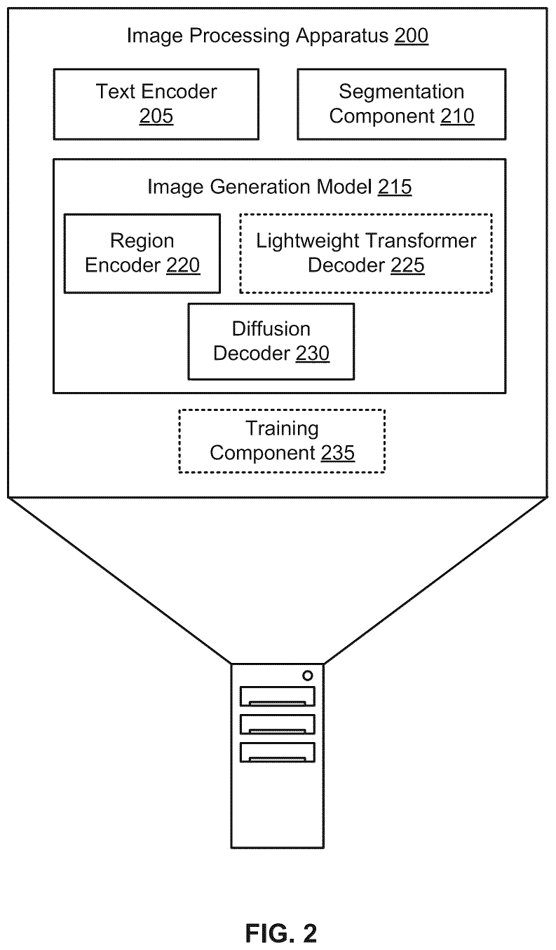

In some examples, image processing apparatus 100 applies one or more of a delete, move, or resize transformation. In some examples, image processing apparatus 100 obtains a text prompt, where the edited image depicts the scene with the modified object as described by the text prompt. In some examples, image processing apparatus 100 obtains a set of additional encoded image elements from a different image including a different object, where the edited image depicts the scene with the different object. Image processing apparatus 100 is an example of, or includes aspects of, the corresponding element described with reference to FIG. 2.

FIG. 2 shows an example of an image processing apparatus 200 according to aspects of the present disclosure. The example shown includes image processing apparatus 200, text encoder 205, segmentation component 210, image generation model 215 including region encoder 220, lightweight transformer decode 225, and diffusion decoder 230, and training component 235. Image processing apparatus 200 is an example of, or includes aspects of, the corresponding element described with reference to FIG. 1.

Text encoder 205 is configured to process an input text and generate text features that can be used to, for example, condition the generation process of image generation model 215. In some cases, a text encoder includes a tokenizer, a token-embedding lookup table, and a transformer-based artificial neural network (ANN) configured to adjust the initial embeddings of the input sequence to encode contextual information. Examples of a text encoder include Flan-T5 and the CLIP text encoder.

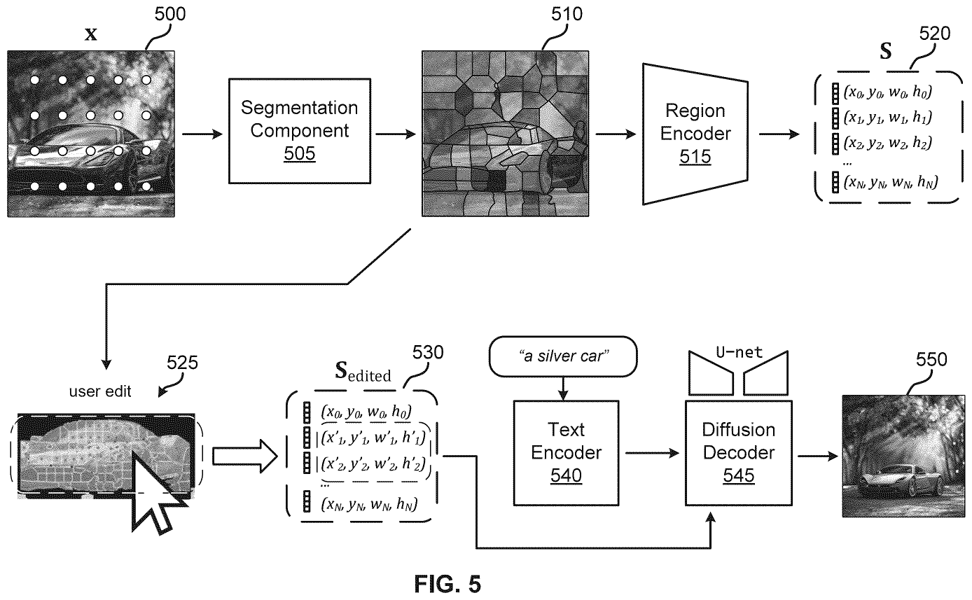

A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a. Text encoder 205 is an example of, or includes aspects of, the corresponding element described with reference to FIG. 5.

Segmentation component 210 is configured to segment an input image into a plurality of regions. In digital image processing and computer vision, image segmentation is the process of partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics.

Embodiments of segmentation component 210 include a Segment Anything Model (SAM). This model initially overlays a grid of points onto an image (referred to sometimes as “queries”), and then processes these points to generate segmentation masks. SAM utilizes a vision transformer architecture to first extract rich visual features from the input image. These features are then combined with positional encodings of the query points.

SAM further includes a mask decoder, which takes the encoded image features and prompts to predict segmentation masks. This decoder employs a series of transformer layers to iteratively refine the mask predictions. The masks are pixel-wise labels that define semantically similar regions of the image. In some embodiments, the segmentation component 210 further performs Simple Linear Iterative Clustering (SLIC) to operate in the feature space of the SAM model to adjust the initial set of regions. For example, in some cases, the final predicted segmentation masks are not suitable as editable image regions, since the segments can vary too much in shape and size. Accordingly, some embodiments apply the predicted SAM affinity map s(m, n)∈[0, 1] with the Euclidean distance in spatial coordinates d(m, n), between pixel location index m and query point n. Then, each pixel m is grouped into a query element n:

$$g ( m ) = {arg max}_{n ∈ \{ 1 , 2 , … , N \}} [ s ( m , n ) - β \cdot d ( m , n ) ] \qquad ( 1 )$$

where hyperparameter β is used to balance between feature similarity and spatial distance. At this point, all pixels are assigned to one of the N query elements (e.g., 16×16 elements) resulting in a set of disjoint regions A. Embodiments may then post-process each region an by performing a connected components process and selecting the largest group of pixels to ensure each region is contiguous. In some cases, this can result in a small percentage of pixels (˜0.1%) being dropped from a region. The output of segmentation component 210 is a set of masks corresponding to the contiguous regions of the image. Centroid points and bounding boxes may be obtained trivially from the masks, which are themselves sets of pixels.

According to some aspects, segmentation component 210 segments the image to obtain an initial set of regions. In some examples, segmentation component 210 performs linear clustering on the initial set of regions to obtain the set of regions. Segmentation component 210 is an example of, or includes aspects of, the corresponding element described with reference to FIG. 5.

Image generation model 215 encodes the set of regions using region encoder 220 to obtain embeddings for each region. Embodiments of region encoder 220 include, for example, a convolutional neural network (CNN). Particularly, some embodiments of region encoder 220 include a KL Auto-encoder structure with multiple downsampling CNN layers. A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input. The output of the CNN is a vector representation of the input image (or in the case, regions of an image) that is understandable by a decoder for a downstream task. The system associates the embeddings of each region to their corresponding centroid points and bounding boxes, forming a plurality of image elements.

During training, the image generation model 215 further includes a lightweight transformer decoder 225. The lightweight transformer decoder 225 is trained simultaneously with the region encoder 220 to teach the region encoder 220 to generate embeddings that result in more accurate reconstructions of the input image. That is, in some cases, training the region encoder 220 with the lightweight transformer decoder 225 first, then discarding the lightweight transformer decoder 225, attaching the diffusion decoder 230, and then training the diffusion decoder 230 while holding parameters of the region encoder 220 fixed results in the most performant encoder-decoder structure for the image generation model 215.

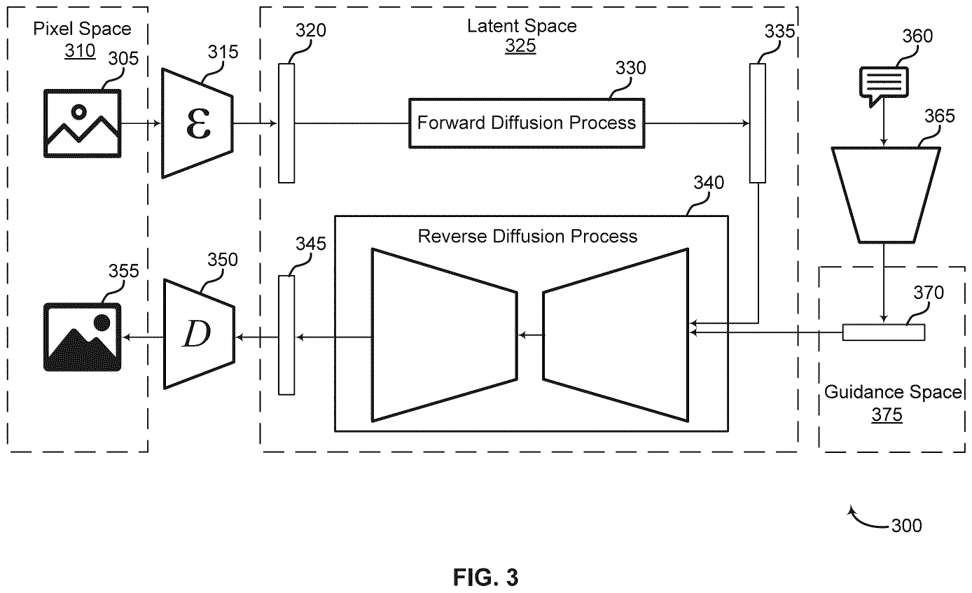

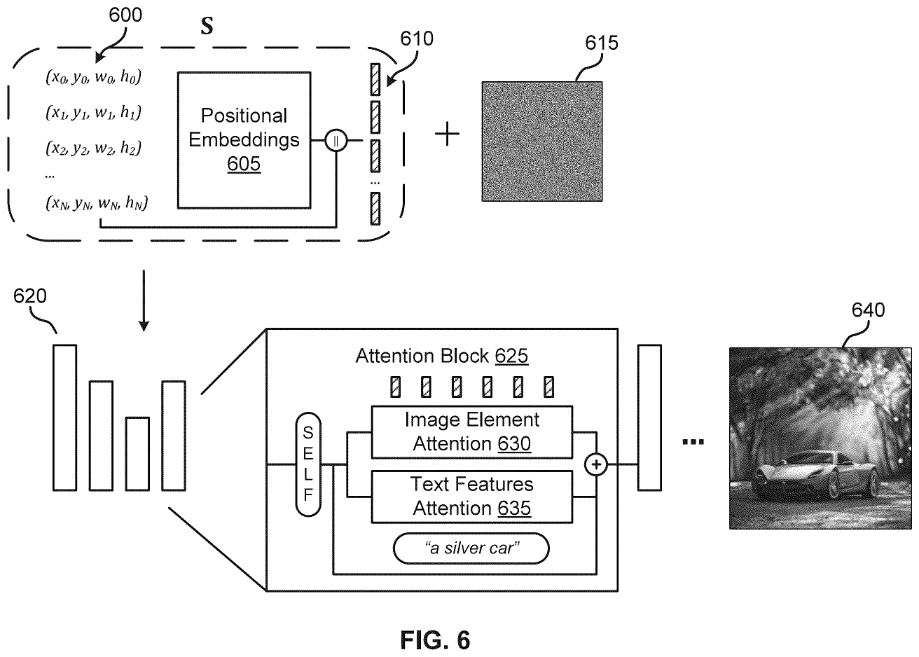

Diffusion decoder 230 is configured to process the plurality of image elements to generate an edited image. Embodiments of diffusion decoder 230 include a diffusion U-Net, which will be described in greater detail with reference to FIGS. 2-3. Region encoder 220 is an example of, or includes aspects of, the corresponding element described with reference to FIG. 5. Diffusion decoder 230 is an example of, or includes aspects of, the corresponding element described with reference to FIGS. 5 and 6.

According to some aspects, image generation model 215 encodes, using an encoder of an image generation model 215 (e.g., the region encoder 220), a set of regions of the image to obtain a set of encoded image elements. In some examples, image generation model 215 generates, using a decoder of the image generation model 215 (e.g., the diffusion decoder 230), an edited image depicting the scene with the modified object based on the set of encoded image elements including the transformed image element. In some examples, image generation model 215 individually encodes each of the set of regions to obtain patch embedding (e.g., the region embedding) for each region, where each of the set of encoded image elements includes a patch embedding. In some aspects, each of the set of encoded image elements further includes a location and a bounding box. In some examples, image generation model 215 conditions the generation of the edited image with the text features and the set of encoded image elements.

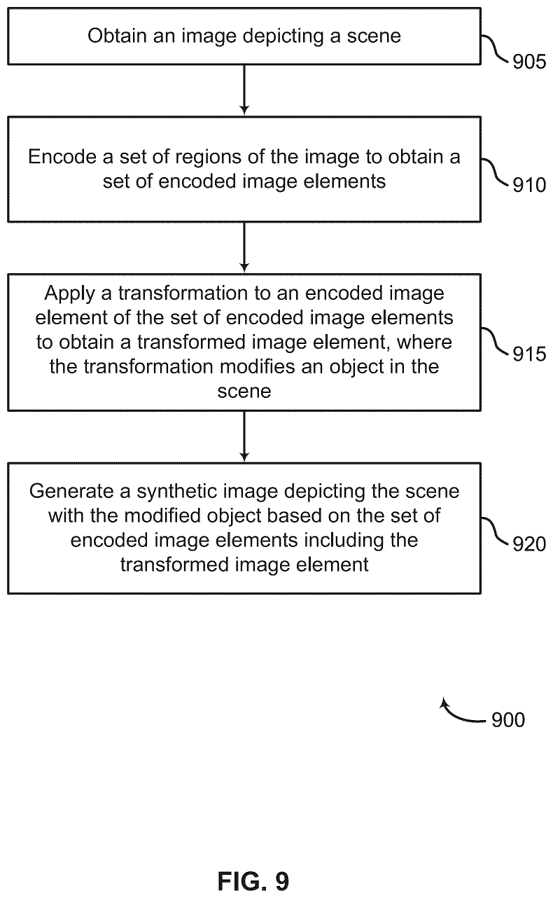

Training component 235 updates parameters of image generation model 215 during one or more training phases. For example, training component 235 may update parameters of region encoder 220 during a first training phase along with parameters of lightweight transformer decoder 225 and may update parameters of diffusion decoder 230 during a second training phase while leaving parameters of region encoder 220 fixed. Additional detail regarding training methods and schemes is provided with reference to FIGS. 9-11.

According to some aspects, training component 235 trains, using training data and the set of encoded image elements, an image generation model 215 to generate an edited image based on the set of encoded image elements. In some examples, training component 235 drops one or more of the set of encoded image elements to obtain a reduced set of encoded image elements, where the image generation model 215 is trained to reproduce the ground-truth image using the reduced set of encoded image elements. In some examples, training component 235 trains an encoder of the image generation model 215 to generate the set of encoded image elements. In some examples, training component 235 trains the encoder of the image generation model 215 simultaneously with a lightweight transformer decoder 225. In some examples, training component 235 replaces the lightweight transformer decoder 225 with a diffusion-based decoder. In some examples, training component 235 freezes parameters of the encoder while updating parameters of the diffusion-based decoder.

FIG. 3 shows an example of a guided latent diffusion model 300 according to aspects of the present disclosure. The guided latent diffusion model 300 depicted in FIG. 3 is an example of, or includes aspects of, the image generation model 215 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and fine-tuned jointly with the reverse diffusion process 340.

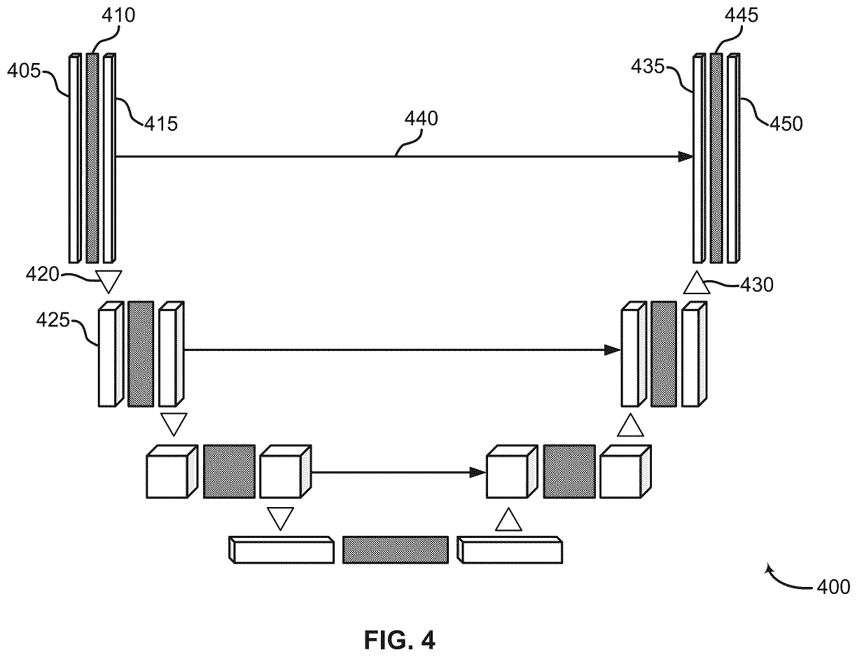

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340. In embodiments of the image generation model described herein, the guidance features 370 may include text features from a text embedding as well as features from the image elements described above, and to be described in further detail with reference to FIGS. 4-5.

FIG. 4 shows an example of a U-Net 400 according to aspects of the present disclosure. In some examples, U-Net 400 is an example of the component that performs the reverse diffusion process 340 of guided diffusion model 300 described with reference to FIG. 2 and includes architectural elements of the image generation model 215 described with reference to FIG. 2. The U-Net 400 depicted in FIG. 4 is an example of, or includes aspects of, the architecture used within the reverse diffusion process described with reference to FIG. 7.

In some examples, diffusion models are based on a neural network architecture known as a U-Net. The U-Net 400 takes input features 405 having an initial resolution and an initial number of channels and processes the input features 405 using an initial neural network layer 410 (e.g., a convolutional network layer) to produce intermediate features 415. The intermediate features 415 are then down-sampled using a down-sampling layer 420 such that down-sampled features 425 have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having a same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415.

FIG. 5 shows an example of a pipeline for controllable image synthesis according to aspects of the present disclosure. The example shown includes input image 500, segmentation component 505, image segmented into regions 510, region encoder 515, image elements 520, input user edit 525, edited image elements 530, text prompt 535, text encoder 540, diffusion decoder 545, and edited image 550.

Segmentation component 505, region encoder 515, and text encoder 540 are examples of, or include aspects of, the corresponding elements described with reference to FIG. 2. Diffusion decoder 545 is an example of, or includes aspects of, the corresponding element described with reference to FIGS. 2 and 6.

Images can be represented as a tensor x∈ [symbol] ^{H×W×3}. Embodiments are configured to generate representations of images as sets of image elements that capture the contents of the images while being naturally editable. In some cases, each image element corresponds to an identifiable part of objects, commonly known as “stuff” classes. Further, the image elements persist within the manifold of real image elements after editing operations such as deletions or rearrangements. For example, in some cases, conventionally representing an image as a grid of latent codes may not be amenable for spatial editing, since the grid location of the unoccupied latent code cannot be left as blank before being passed to a decoder.

Accordingly, embodiments segment an input image into disjoint and contiguous regions based on semantic similarity and spatial proximity, the regions being denoted as A={a₁, a₂, . . . , a_{N}}, where aₙ∈ [symbol] ^{H}^{ₙ}^{×W}^{ₙ}^{×3} is a cropped masked region of the image. In some embodiments, a H×W=512×512 image is split into N=256 elements, with an average region size of 1024 pixels.

As described above with reference to FIG. 2 and Equation (1), the segmentation component 505 may process input image 500 to generate regions of a similar size, e.g. image segmented into regions 510, using Simple Linear Iterative Clustering (SLIC). The operation described by Equation (1) may be run multiple iterations to achieve similarly sized regions.

Next, region encoder 515 encodes each region separately to generate a region embedding that is agnostic to its spatial location. In some embodiments, to ensure that size parameters are decoupled from the appearance features, every region is resized to the same size (e.g., the same dimension bounding box) before being passed into region encoder 515. Embodiments of the region encoder 515 are based on the architecture of the KL Auto-encoder from stable diffusion, with 4 downsampling layers. A training phase trains the region encoder 515 (denoted ε) along with a lightweight transformer decoder [symbol] _{light} to reconstruct an input image x with a Euclidean loss:

$${ε}^{*} = arg {min}_{ε} {min}_{{𝒟}_{light}} {ℓ}_{2} ( x , {𝒟}_{light} ( S ) ) , \qquad ( 2 )$$

$$where S = \{ ( ε ( {a}_{n} ) , {p}_{n} ) \}$$

where pₙ are patch properties for each region, including the centroid location (xₙ, yₙ) and bounding box size (wₙ, hₙ).

The region embeddings and their associated centroids and bounding boxes form image elements 520, denoted S. A user can apply edits to the regions via a user interface by, for example, selecting one or more segments, and then drag-moving the regions, deleting the segments by hitting a key or GUI element, or resizing the regions. These edits translate to edits of the image elements by adjusting their pₙ to obtain edited image elements 530. According to some aspects, when the user performs a movement or resize operation, the image elements that collide with the edited image elements are automatically deleted. In some cases, for deletion, instead of removing the image elements from the set, embodiments simply zero out all values including the centroid, bounding box, and embedding values so as to maintain a uniform input length to diffusion decoder 545.

Diffusion decoder 545 then processes the edited image elements 530 to generate edited image 550 therefrom, which depicts a seamless version of the user edits. For example, as shown, edited image 550 includes a scaled down version of the car, with information such as the passenger side lights and wheel features inferred from the generative process. Optionally, the generation may be further conditioned by a text prompt. For example, the text encoder 540 may process a text prompt “a silver car” to obtain text features that can be used as guidance along with the features from edited image elements 530. In this case, the edited image 550 will depict the scaled down car as a silver car.

FIG. 6 shows an example of a pipeline for generating edited images 640 from image elements 600 according to aspects of the present disclosure. The example shown includes image elements 600, positional embeddings 605, input tokens 610, noise map 615, diffusion decoder 620, attention block 625 including image element attention 630 and text features attention 635, and edited image 640.

FIG. 6 includes elements that are the same as or similar to elements from FIG. 5, but mainly focuses on the decoding pipeline. It will be appreciated that description of the same or similar elements can be found elsewhere in the specification.

Once the system has processed the input image and generated the initial image elements, and the user has edited the segmented regions of the input image and the system has translated those edits to form the edited image elements, e.g. image elements 600, the system may then combine image elements 600 with positional embeddings 605 to form input tokens 610. In some embodiments, the positional embeddings 605 are simply embeddings of the centroids and the bounding box information, formed so as to match one or more dimensions of the region embeddings.

The diffusion decoder 620 may be a guided latent diffusion model as described with reference to FIG. 3. Accordingly, diffusion decoder 620 is pretrained to denoise noise map 615. The diffusion decoder 620 may have cross-attention layers, e.g. image element attention 630, that are finetuned to use input tokens 610 to condition the generation process. When the user provides a text prompt, diffusion decoder 620 may further utilize text features attention 635 to condition the generation. In this way, diffusion decoder 620 synthesizes edited image 640 that depicts the edits represented in image elements 600 with optional additional guidance from a text prompt.

### Generating Edited Images

FIG. 7 shows a diffusion process 700 according to aspects of the present disclosure. In some examples, diffusion process 700 describes an operation of the image generation model 215 described with reference to FIG. 2, such as the reverse diffusion process 340 of guided diffusion model 300 described with reference to FIG. 3.

As described above with reference to FIG. 3, using a diffusion model can involve both a forward diffusion process 705 for adding noise to an image (or features in a latent space) and a reverse diffusion process 710 for denoising the images (or features) to obtain a denoised image. The forward diffusion process 705 can be represented as q(xₜ|xₜ₋₁), and the reverse diffusion process 710 can be represented as p(xₜ₋₁|xₜ). In some cases, the forward diffusion process 705 is used during training to generate images with successively greater noise, and a neural network is trained to perform the reverse diffusion process 710 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 710, the model begins with noisy data XT, such as a noisy image 715 and denoises the data to obtain the p(xₜ₋₁|xₜ). At each step t−1, the reverse diffusion process 710 takes xₜ, such as first intermediate image 720, and t as input. Here, t represents a step in the sequence of transitions associated with different noise levels, The reverse diffusion process 710 outputs xₜ₋₁, such as second intermediate image 725 iteratively until x_{T} reverts back to x₀, the original image 730. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 3 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 4 )$$

where p(x_{T})=N (x_{T}; 0, 1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

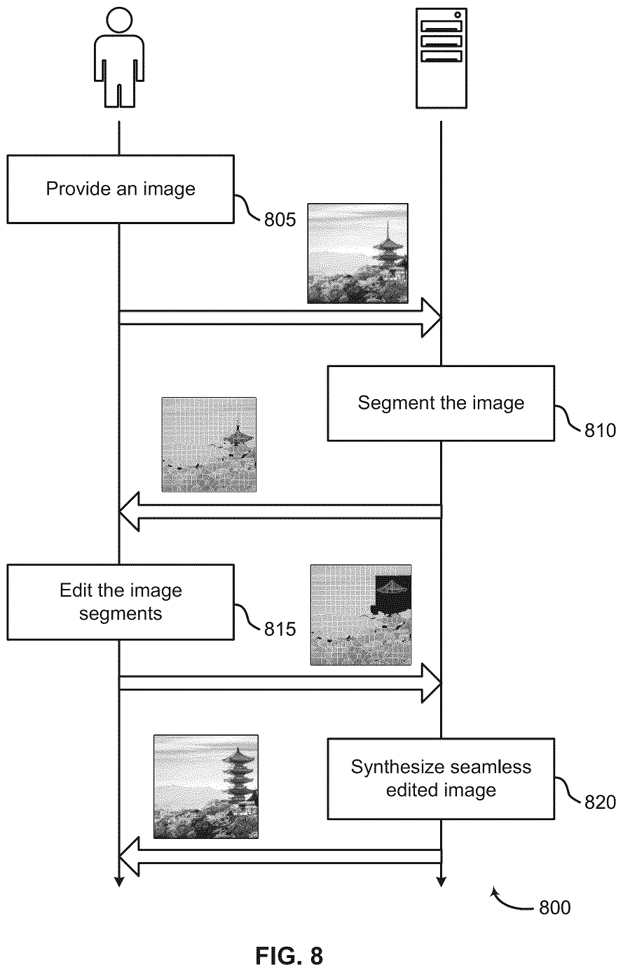

FIG. 8 shows an example of a method 800 for providing an edited image to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, a user provides an image. The user may provide the image via a user interface as described with reference to FIG. 1. The image may depict one or more object that the user wishes to edit. In this example, the user may wish to increase the height of the shrine depicted in the image.

At operation 810, the system segments the image. In some cases, the operations of this step refer to, or may be performed by, a segmentation component as described with reference to FIG. 2. Segmenting the image involves obtaining a set of contiguous regions from the image, which are sometimes referred to as “superpixels.” The system then provides the segmented image to the user. On the back end, the system stores an initial set of image elements corresponding to each of the regions.

At operation 815, the user edits the image segments. The user may do so via the user interface. According to some aspects, the user may perform editing operations including but not necessarily limited to dragging, resizing, and deletion of the segments. The system then receives these edits from the user and translates the edits to the segments into changed values of the image elements, including changes to each image element's centroid and bounding box, and in the case of deletion, zeroing out each image element's corresponding region embedding.

At operation 820, the system synthesizes a seamless edited image. In some cases, the operations of this step refer to, or may be performed by, an image generation model as described with reference to FIG. 2. The image generation model may synthesize the seamless edited image by performing a reverse diffusion process as described with reference to FIG. 7, where the reverse diffusion process is conditioned using features from the image elements.

FIG. 9 shows an example of a method 900 for controllable image synthesis according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 905, the system obtains an image depicting a scene. In some cases, the operations of this step refer to, or may be performed by, an image processing apparatus as described with reference to FIGS. 1 and 2. For example, the image processing apparatus may receive the image as specified by a user operating a user interface as described with reference to FIG. 1. The user may select an image from a set of stock images, upload an image, or otherwise specify the image.

In an example, the encoder may encode a first region (e.g., a portion of a foreground object such as a car) and a second region (e.g., a background region) obtain a first encoded image element and a second encoded image element, respectively. The first encoded image element and the second encoded image element can be distinct image element encodings that individually represent distinct parts of an original image.

At operation 910, the system encodes a set of regions of the image to obtain a set of encoded image elements. In some cases, the operations of this step refer to, or may be performed by, an image generation model as described with reference to FIG. 2. For example, aa region encoder of the image generation model may perform a convolution operation on each region of the image to obtain region embeddings, each of which are associated with positional information of each region, thereby forming image elements. Additional detail regarding the formation of the image elements is described with reference to FIG. 5.

At operation 915, the system applies a transformation to an encoded image element of the set of encoded image elements to obtain a transformed image element, where the transformation modifies an object in the scene. In some cases, the operations of this step refer to, or may be performed by, an image processing apparatus as described with reference to FIGS. 1 and 2. The image processing apparatus may obtain user edits via the user interface. The edits may include, but are not limited to, a delete, move, or resize edit. The image processing apparatus may then edit the positional information of the image elements corresponding to the regions edited by the user to obtain transformed image elements.

In the foregoing example, a transformation such as a resizing operation can be applied to the first encoded image element to obtain a transformed image element. The transformation modifies an object in the scene located withing the first region of the image. The result can be an encoding that represents an object or a portion of an object (e.g., a portion of a car) with a different size than the first encoded image element.

At operation 920, the system generates an edited image depicting the scene with the modified object based on the set of encoded image elements including the transformed image element. In some cases, the operations of this step refer to, or may be performed by, an image generation model as described with reference to FIG. 2. For example, the image generation model may decode the set of encoded image elements including the transformed image element according to the decoding pipeline described with reference to FIG. 6.

In the foregoing example, an edited image is generated depicting the scene with the modified object based on the transformed image element and the second encoded image element. For example, the edited image can include a car that is a different size than the corresponding car in the original image.

FIG. 10 is a flow diagram depicting an algorithm as a step-by-step procedure 1000 in an example implementation of operations performable for training a machine-learning model. In some embodiments, the procedure 1000 describes an operation of the training component 235 described for configuring the encoder and the decoder(s) of the image generation model 215 as described with reference to FIG. 2. The procedure 1000 provides one or more examples of generating training data, use of the training data to train a machine-learning model, and use of the trained machine-learning model to perform a task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and edited data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore, once trained, is configured to perform that task based on subsequent data received as an input and processed by the machine-learning model.

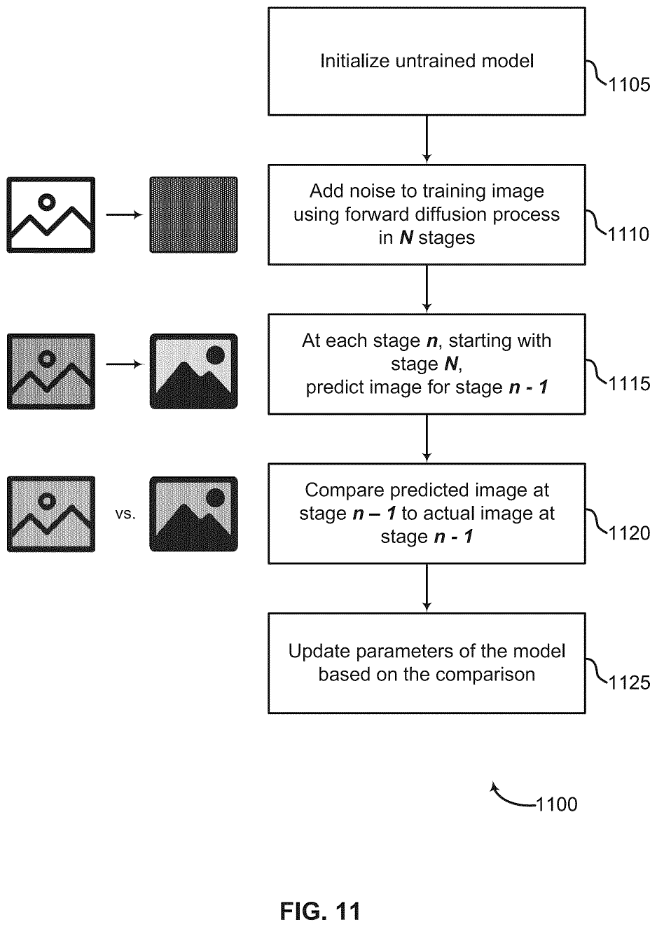

FIG. 11 shows an example of a method 1100 for training a diffusion model according to aspects of the present disclosure. In some embodiments, the method 1100 describes an operation of the training component 235 described for configuring the image generation model 215 as described with reference to FIG. 2. The method 1100 represents an example for training a reverse diffusion process as described above with reference to FIG. 7. In some examples, these operations are performed by a system including a processor executing a set of codes to control functional elements of an apparatus, such as the guided diffusion model described in FIG. 3.

Additionally or alternatively, certain processes of method 1100 may be performed using special-purpose hardware. Generally, these operations are performed according to the methods and processes described in accordance with aspects of the present disclosure. In some cases, the operations described herein are composed of various substeps or are performed in conjunction with other operations.

At operation 1105, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1110, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1115, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1120, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1125, the system updates parameters of the model based on the comparison. For example, parameters of a U-Net may be updated using gradient descent. Time-dependent parameters of the Gaussian transitions can also be learned.

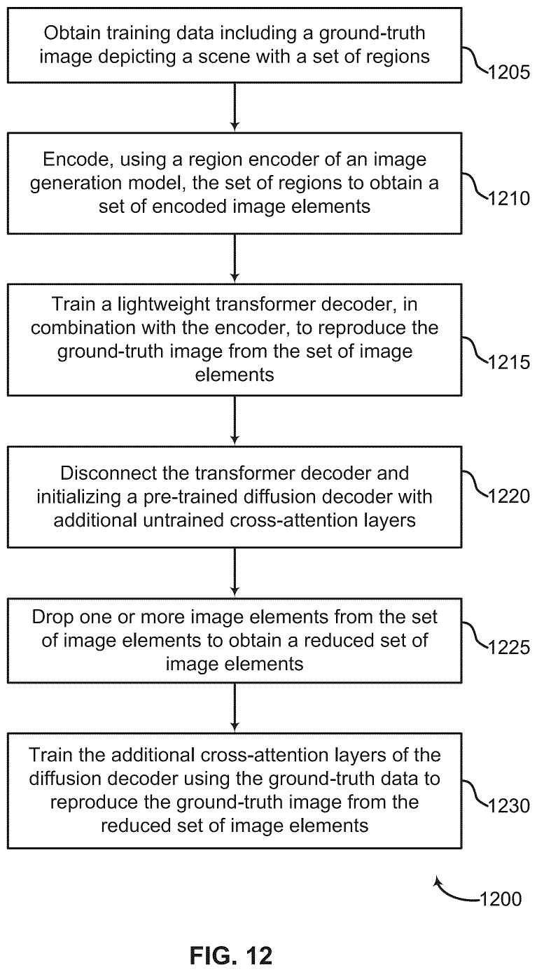

FIG. 12 shows an example of a method 1200 for staged training according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1205, the system obtains training data including a ground-truth image depicting a scene with a set of regions. In some cases, the operations of this step refer to, or may be performed by, an image processing apparatus as described with reference to FIGS. 1 and 2.

At operation 1210, the system encodes, using a region encoder of an image generation model, the set of regions to obtain a set of encoded image elements. In some cases, the operations of this step refer to, or may be performed by, an image generation model as described with reference to FIG. 2. Additional detail regarding the encoding process is described with reference to FIG. 5.

At operation 1215, the system trains a lightweight transformer decoder, in combination with the encoder, to reproduce the ground-truth image from the set of image elements. In some cases, the operations of this step refer to, or may be performed by, a training component as described with reference to FIG. 2. The training component may train both the encoder and the lightweight transformer decoder to predict region embeddings and an edited image from the region embeddings, respectively. The training component may implement an algorithm such as the one described with reference to FIG. 10.

At operation 1220, the system disconnects the transformer decoder and initializes a pre-trained diffusion decoder with additional untrained cross-attention layers. The system may add an equivalent number of untrained cross-attention layers as there are existing cross-attention layers dedicated to incorporating text features, though embodiments are not limited thereto.

At operation 1225, the system drops one or more image elements from the set of image elements to obtain a reduced set of image elements. According to some aspects, while training without dropout is effective for reconstructing an original input image with unedited image elements, it can be insufficient for reconstructing an accurate image using edited image elements. This may be due to the distributional discrepancies introduced during the edit process, including overlapping or missing elements, and gaps.

Some embodiments use a modified segmentation component including a model known as Semantic SAM, which enables segmentation at a controllable level of granularity, to obtain a training set including images with a diverse set of object masks (segmentations). Then, a random object mask is overlaid onto the input image (that is, the regions of the mask may not be semantically relevant to the input image), and image elements overlapping with the mask are dropped out. In some cases, this still confers an unwanted correlation between object edges and the prepared image elements, and the model can learn to inpaint object boundaries aligned with those of the dropped image elements. Accordingly, some embodiments perform a Random Partition process, which randomly divides the image to obtain the image elements in the training data. Then, these randomly obtained segments are dropped out to obtain training data.

At operation 1230, the system trains the additional cross-attention layers of the diffusion decoder using the ground-truth data to reproduce the ground-truth image from the reduced set of image elements. In an example, the diffusion decoder may include base model [symbol] with parameters [symbol] and additional cross-attention layers for each existing cross-attention layer dedicated to text embeddings. The parameters of the additional cross-attention layers may be denoted as [symbol] . The model receives a noisy latent zₜ as input and predicts corresponding noise \hat{∈}. In this case, in addition to the text embedding condition C, the model further conditions its predictions on the reduced set of image elements S. The objective function for training the diffusion decoder with the additional cross-attention layers used for considering the input image elements becomes:

$${ℒ}_{image generation model} = {𝔼}_{z , ϵ \sim 𝒩 ( 0 , I ) , t} {‖ ϵ - 𝒰 ( {z}_{t} , t , C , S ; {θ}_{𝒰} , {θ}_{𝒮} ) ‖}_{2}^{2} \qquad ( 5 )$$

where ∈˜ [symbol] (0, 1) refers to noise sampled from a Gaussian distribution, and t refers to the diffusion timestep. In some embodiments, the parameters [symbol] introduced to the pretrained diffusion model [symbol] are randomly initialized. In some embodiments, during this training, both the parameters of the region encoder (described with reference to FIG. 5) and the text encoder are frozen during this process.

### Results

FIG. 13 shows an example of results of the image element pipeline as compared to conventional editing approaches according to aspects of the present disclosure. The example shown includes input image 1300, image segmented into regions 1305, input user edit 1310, output from the present embodiments 1315, and outputs from various other controllable synthesis approaches 1320.

In this example, the image processing system processes input image 1300 to form image segmented into regions 1305. Then, a user makes edits to image segmented into regions 1305 via a user interface. For example, as shown by input user edit 1310, the user may select the image elements corresponding to the overhanging ridge in the desert scene and move these image elements up. The image elements that otherwise would have been obfuscated by the edit may be deleted.

Output from the present embodiments 1315 depicts the results of inputting the user edit into the image processing system of the present embodiments. In contrast, outputs from various other controllable synthesis approaches 1320 depicts the results of the most comparable user edits made using conventional approaches.

For example, the top image of 1320 depicts an approach in which the user describes the desired edit “raise the ridge” via text. This approach utilizes a model that is trained to incorporate additional guidance features at inference time without retraining. However, despite maintaining similar scene features, the edit is not reflected, as the ridge has not risen.

The middle image of 1320 depicts an approach in which an external image as the source of the edit (e.g., a rough stroke image of the edit). While the ridge appears to have moved, it is disconnected at both ends and appears to be floating in the sky Further, the colors and the scenic elements have changed from the input image.

The bottom image of 1320 depicts an approach in which a diffusion model, which has been finetuned on caption pairs describing edits to an image, is used. Despite the text instructions, the ridge has not risen, and the totality of the scene has changed. For example, the scene is now lush with vegetation, whereas the input image depicts a barren desert.

FIG. 14 shows an example of a computing device 1400 according to aspects of the present disclosure. The example shown includes computing device 1400, processor(s) 1405, memory subsystem 1410, communication interface 1415, I/O interface 1420, user interface component(s), and channel 1430.

In some embodiments, computing device 1400 is an example of, or includes aspects of, an image generation apparatus as described in FIGS. 1 and 2. In some embodiments, computing device 1400 includes one or more processors 1405 are configured to execute instructions stored in memory subsystem 1410 to obtain an image depicting a scene; encode, using an encoder of an image generation model, a plurality of regions of the image to obtain a plurality of encoded image elements; apply a transformation to an encoded image element of the plurality of encoded image elements to obtain a transformed image element, wherein the transformation modifies an object in the scene; and generate, using a decoder of the image generation model, an edited image depicting the scene with the modified object based on the plurality of encoded image elements including the transformed image element.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating systems. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

Accordingly, the present disclosure includes the following aspects.

A method for image generation is described. One or more aspects of the method include obtaining an image depicting a scene; encoding, using an encoder of an image generation model, a plurality of regions of the image to obtain a plurality of encoded image elements; applying a transformation to an encoded image element of the plurality of encoded image elements to obtain a transformed image element, wherein the transformation modifies an object in the scene; and generating, using a decoder of the image generation model, an edited image depicting the scene with the modified object based on the plurality of encoded image elements including the transformed image element.

Some examples of the method, apparatus, non-transitory computer readable medium, and system further include segmenting the image to obtain an initial plurality of regions. Some examples further include performing linear clustering on the initial plurality of regions to obtain the plurality of regions. Some examples of the method, apparatus, non-transitory computer readable medium, and system further include individually encoding each of the plurality of regions to obtain patch embedding for each region, wherein each of the plurality of encoded image elements includes a patch embedding. In some aspects, each of the plurality of encoded image elements further includes a location and a bounding box.

Some examples of the method, apparatus, non-transitory computer readable medium, and system further include changing the value of the location or the value of the bounding box of the encoded image element to obtain the transformed image element. Some examples of the method, apparatus, non-transitory computer readable medium, and system further include applying one or more of a delete, move, or resize transformation. Some examples of the method, apparatus, non-transitory computer readable medium, and system further include obtaining a text prompt, wherein the edited image depicts the scene with the modified object as described by the text prompt.

Some examples of the method, apparatus, non-transitory computer readable medium, and system further include encoding the text prompt to obtain text features. Some examples further include conditioning the generation of the edited image with the text features and the plurality of encoded image elements. Some examples of the method, apparatus, non-transitory computer readable medium, and system further include obtaining a plurality of additional encoded image elements from a different image including a different object, wherein the edited image depicts the scene with the different object.

A method for image generation is described. One or more aspects of the method include obtaining training data including a ground-truth image depicting a scene with a plurality of regions; encoding the plurality of regions to obtain a plurality of encoded image elements; and training, using the training data and the plurality of encoded image elements, an image generation model to generate an edited image based on the plurality of encoded image elements.

Some examples of the method, apparatus, non-transitory computer readable medium, and system further include dropping one or more of the plurality of encoded image elements to obtain a reduced set of encoded image elements, wherein the image generation model is trained to reproduce the ground-truth image using the reduced set of encoded image elements. Some examples of the method, apparatus, non-transitory computer readable medium, and system further include training an encoder of the image generation model to generate the plurality of encoded image elements.

Some examples of the method, apparatus, non-transitory computer readable medium, and system further include training the encoder of the image generation model simultaneously with a lightweight transformer decoder. Some examples further include replacing the lightweight transformer decoder with a diffusion-based decoder. Some examples of the method, apparatus, non-transitory computer readable medium, and system further include freezing parameters of the encoder while updating parameters of the diffusion-based decoder. In some aspects, the training data further comprises a ground-truth text describing an object in the ground-truth image.

An apparatus for image generation is described. One or more aspects of the apparatus include at least one processor; at least one memory storing instructions executable by the at least one processor; and an image generation model comprising parameters stored in the at least one memory, wherein the image generation model is trained encode a plurality of regions of an input image to obtain a plurality of encoded image elements, to obtain a transformed image element corresponding to at least one or the encoded image elements, and to generate an edited image based on the plurality of encoded image elements including the transformed image element.

In some aspects, the image generation model comprises a diffusion model. Some examples of the apparatus, system, and method further include a text encoder configured to encode a text prompt. Some examples of the apparatus, system, and method further include a segmentation component configured to segment the image to obtain the plurality of regions. Some examples of the apparatus, system, and method further include a user interface configured to obtain the transformed image element.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an image depicting a scene;
encoding, using an encoder of an image generation model, a first region of the image to obtain a first encoded image element;
applying a transformation to the first encoded image element to obtain a transformed image element, wherein the transformation modifies an object in the scene located withing the first region of the image; and
generating, using a decoder of the image generation model, an edited image depicting the scene with the modified object based on the transformed image element.

2. The method of claim 1, further comprising:
segmenting the image to obtain an initial plurality of regions; and
performing linear clustering on the initial plurality of regions to obtain the first region.

3. The method of claim 1, wherein the encoding of the first region comprises:
individually encoding each of a plurality of regions to obtain a patch embedding for each of the plurality of regions.

4. The method of claim 1, wherein:
the first encoded image element includes location information and size information of the first region.

5. The method of claim 1, wherein the image generation model is trained by training the encoder simultaneously with a training decoder and replacing the training decoder with a diffusion-based decoder.

6. The method of claim 5, wherein the image generation model is trained by freezing parameters of the encoder while updating parameters of the diffusion-based decoder.

7. The method of claim 1, wherein the image generation model is trained by obtaining a plurality of encoded image elements and dropping one or more of the plurality of encoded image elements to obtain a reduced set of encoded image elements.

8. The method of claim 6, wherein generating the edited image comprises:
encoding a text prompt to obtain text features; and
conditioning the generation of the edited image with the text features.

9. The method of claim 1, further comprising:
obtaining an additional encoded image element from a different image including a different object, wherein the edited image is generated based on the additional encoded image element and depicts the scene with the different object.

10. A non-transitory computer readable medium storing code for image processing, the code comprising instructions that, when executed by at least one processor, cause the at least one processor to perform operations comprising:
segmenting an image to obtain a first region of the image;
encoding, using an encoder of an image generation model, the first region of the image to obtain a first encoded image element;
editing the first encoded image element based on a user edit to obtain a transformed image element; and
generating, using a decoder of the image generation model, an edited image based on the transformed image element.

11. The non-transitory computer readable medium of claim 10, wherein segmenting the image comprises:
performing linear clustering on an initial plurality of regions to obtain the first region.

12. The non-transitory computer readable medium of claim 10, wherein encoding the first region comprises:
individually encoding each of a plurality of regions to obtain a patch embedding for each of the plurality of regions.

13. The non-transitory computer readable medium of claim 12, wherein the image generation model is trained by training the encoder simultaneously with a training decoder and replacing the training decoder with a diffusion-based decoder.

14. The non-transitory computer readable medium of claim 13, wherein the image generation model is trained by freezing parameters of the encoder while updating parameters of the diffusion-based decoder.

15. The non-transitory computer readable medium of claim 10, wherein the image generation model is trained by obtaining a plurality of encoded image elements and dropping one or more of the plurality of encoded image elements to obtain a reduced set of encoded image elements.

16. An apparatus comprising:
at least one processor;
at least one memory storing instructions that, when executed by the at least one processor, cause the processor to perform operations comprising:
obtaining an image depicting a scene;
encoding, using an encoder of an image generation model, a first region of the image to obtain a first encoded image element;
applying a transformation to the first encoded image element to obtain a transformed image element, wherein the transformation modifies an object in the scene located withing the first region of the image; and
generating, using a decoder of the image generation model, an edited image depicting the scene with the modified object based on the transformed image element.

17. The apparatus of claim 16, wherein:
the image generation model comprises a diffusion model.

18. The apparatus of claim 16, further comprising:
a text encoder configured to encode a text prompt.

19. The apparatus of claim 16, further comprising:
a segmentation component configured to segment the image to obtain a plurality of regions.

20. The apparatus of claim 16, further comprising:
a user interface configured to obtain the transformed image element.
